(19) United States
(12) Patent Application Publication
(10) Pub. No.: US 2015/0067854 A1
(43) Pub. Date: Mar. 5, 2015

(54) APPARATUS AND METHOD FOR MULTI-CHECKING FOR MOBILE MALWARE

(71) Applicant: ELECTRONICS AND TELECOMMUNICATIONS RESEARCH INSTITUTE, Daejeon (KR)

(72) Inventors: Eunyoung KIM, Daejeon (KR); Jaehun LEE, Daejeon (KR); Jinmo PARK, Daejeon (KR); Yosik KIM, Daejeon (KR); Youngtae YUN, Daejeon (KR); Kiwook SOHN, Daejeon (KR)

(21) Appl. No.: 14/305,614

(22) Filed: Jun. 16, 2014

(30) Foreign Application Priority Data
Sep. 3, 2013 (KR) 10-2013-0105328

(51) Int. Cl. H04L 29/06

(52) U.S. Cl. CPC H04L 63/1408; H04L 63/1441
USPC 726/23

(57) ABSTRACT

An apparatus and method for multi-checking for mobile malware are provided. The apparatus for multi-checking for mobile malware includes a communication unit and a user interface (UI) unit. The communication unit communicates with at least one relay server. The UI unit receives an app to be checked from a user before sending the app to the relay server, or provides the user with the check results of the app obtained by a plurality of collection agents located in respective user terminals or emulators based on the app.

### CROSS REFERENCE TO RELATED APPLICATION

This application claims the benefit of Korean Patent Application No. 10-2013-0105328, filed Sep. 3, 2013, which is hereby incorporated by reference in its entirety into this application.

### BACKGROUND OF THE INVENTION

1. Technical Field

The present invention relates generally to an apparatus and method for multi-checking for malware and, more particularly, to an apparatus and method for multi-checking for malware in real time using multiple nodes based on a mobile operating system (OS).

2. Description of the Related Art

About 31 Android-based mobile vaccines have been registered in the App Store (as of January, 2013). If mobile vaccine apps that do not support update versions are taken into account, a larger number of mobile vaccines are present. Accordingly, a user may select a specific vaccine, and may receive results indicative of whether or not malware has been detected by the specific vaccine. However, it is not easy for a user to install and maintain one or more vaccine apps on a single terminal due to the diversity of mobile vaccine detection techniques and signatures.

For example, Korean Patent Application Publication No. 10-2012-0076100 entitled “Malware Detection System in Open Mobile Platform” describes a technology relating to an algorithm for determining malware with respect to an app to be downloaded by a user.

As described above, a method of checking for malware in a mobile device includes a method in which a user installs a mobile vaccine on a terminal or a simulator and then an app is automatically checked for malware when it is installed. However, this method is problematic in that the false positives of an installed app cannot be checked and many problems, such as the deterioration of performance of a terminal, may occur when multiple mobile vaccines have been installed on the terminal.

### SUMMARY OF THE INVENTION

Accordingly, the present invention has been made keeping in mind the above problems occurring in the conventional art, and an object of the present invention is to provide an apparatus and method for multi-checking for malware in real time using multiple nodes based on a mobile OS.

In accordance with an aspect of the present invention, there is provided a method of multi-checking for mobile malware, the method being performed by at least one relay server located between a apparatus for multi-checking for mobile malware and a plurality of collection agents located in respective user terminals or emulators, the method including receiving, by the relay server, an app to be checked from the apparatus for multi-checking for mobile malware; transferring the app to be checked to the plurality of collection agents; collecting vaccine check results of the app to be checked from the plurality of collection agents; and transferring the collected vaccine check results to the apparatus for multi-checking for mobile malware.

The method may further include, before collecting the vaccine check results, installing a mobile vaccine on the user terminals or emulators corresponding to the collection agents.

Transferring the collected vaccine check results to the apparatus for multi-checking for mobile malware may include receiving a reception completion message from the apparatus for multi-checking for mobile malware; transferring an initialization command for one or more user terminals or emulators, corresponding to the collected vaccine check results, to the collection agent; and receiving an initialization finish command indicative that the initialization has been completed in response to the initialization command.

When the app to be checked is transferred to the plurality of collection agents, the app to be checked may be automatically installed on the plurality of collection agents.

In accordance with another aspect of the present invention, there is provided a method of checking for malware of user terminals or emulators using an apparatus for multi-checking for mobile malware, the method including accessing at least one relay server located between the apparatus for multi-checking for mobile malware and a plurality of collection agents located in the respective user terminals or emulators; transferring an app to be checked to the relay server; and receiving vaccine check results for the app to be checked, obtained by the plurality of collection agents, from the relay server.

Receiving the vaccine check results may include transferring, by the relay server, the app to be checked to the plurality of collection agents; and collecting the vaccine check results of the app to be checked from the plurality of collection agents.

In accordance with still another aspect of the present invention, there is provided an apparatus for multi-checking for mobile malware, including a communication unit configured to communicate with at least one relay server; and a user interface (UI) unit configured to receive an app to be checked from a user before sending the app to the relay server, or to provide the user with the check results of the app obtained by a plurality of collection agents located in respective user terminals or emulators based on the app.

The relay server may communicate with the plurality of collection agents located in the respective user terminals or emulators.

The communication unit may be formed of a socket program.

The apparatus may further include a storage unit configured to store the vaccine check results of the app obtained by the plurality of collection agents.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an environment to which a apparatus for multi-checking for mobile malware according to an embodiment of the present invention is applied;

FIG. 2 is a flowchart illustrating a method of multi-checking for mobile malware according to an embodiment of the present invention;

FIG. 3 is a diagram schematically illustrating the configuration of the apparatus for multi-checking for mobile malware according to an embodiment of the present invention;

FIG. 4 is a diagram schematically illustrating a relay server according to an embodiment of the present invention;

FIG. 5 is a diagram schematically illustrating a collection agent according to an embodiment of the present invention; and

FIG. 6 is a diagram illustrating agent commands according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

An apparatus and method for multi-checking for malware in real time using multiple nodes based on a mobile OS according to embodiments of the present invention are described in detail below with reference to the accompanying drawings.

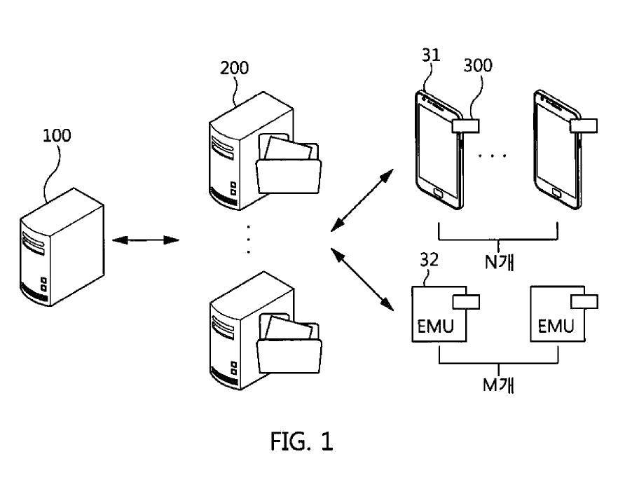

FIG. 1 is a diagram illustrating an environment to which the apparatus for multi-checking for mobile malware according to this embodiment of the present invention is applied.

Referring to FIG. 1 the apparatus 100 for multi-checking for mobile malware according to this embodiment of the present invention operates in conjunction with relay servers 200 and collection agents 300 located in respective N user terminals 31 or respective M emulators 32.

In this embodiment of the present invention, in order to check malware in real time, the task of installing a mobile vaccine in the user terminals 31 or emulators 32, in each of which a mobile OS has been installed, is performed first. Thereafter, the collection agent 300 is installed on each of the user terminals 31 or the emulators 32, and the downloading and installation of apps desired by a user and the collection of vaccine check results are supported through communication between the collection agent 300 and the relay server 200.

The apparatus 100 for multi-checking for mobile malware receives the vaccine check results of an app, that is, a checking object, using the app.

More specifically, the apparatus 100 for multi-checking for mobile malware selects at least one app. The apparatus 100 for multi-checking for mobile malware transfers the selected app to the collection agents 300 through the relay servers 200, and receives the vaccine check results of the selected app from the relay servers 200.

The relay servers 200 function as intermediaries between the apparatus 100 for multi-checking for mobile malware and the collection agents 300.

More specifically, the relay servers 200 store an app received from the apparatus 100 for multi-checking for mobile malware, and sends a multi-vaccine check start command to the collection agents 300. Furthermore, the relay servers 200 receive vaccine check results, corresponding to the multi-vaccine check start command, from the collection agents 300. In this case, each of the relay servers 200 receives vaccine check results from at least one collection agent 300, and transfers the received vaccine check results to the apparatus 100 for multi-checking for mobile malware.

The collection agents 300 install the app received from the relay server 200 and corresponding to the multi-vaccine check start command, and transfer the vaccine check results of the installed app to the relay server 200.

The collection agents 300 located in the respective N user terminals 31 or M emulators 32 based on multiple nodes transfer vaccine check results to the relay server 200. In this case, the relay servers 200 receive all the vaccine check results, and transfer them to the apparatus 100 for multi-checking for mobile malware.

If the number of vaccines to be checked by the apparatus 100 for multi-checking for mobile malware is large, a maximum of N×M collection agents 300 may be operated at the same time. This arrangement may be configured to flexibly extend or reduce a system. Furthermore, if all vaccines may be installed on a single user terminal 31 or emulator 32 in each experimental setup, an experimental network may be configured using a single collection agent 300.

As described above, the apparatus 100 for multi-checking for mobile malware may receive multi-vaccine check results, obtained in parallel in a short period, as feedback, and may reduce a user's confusion attributable to a false-positive result for a specific vaccine.

The apparatus 100 for multi-checking for mobile malware may use various malware detection algorithms, corresponding to respective vaccines, using multiple mobile vaccines, and may perform comparison and analysis on the detection results of the vaccines, thereby being able to contribute to the improvement of the security of a terminal adopting a mobile OS.

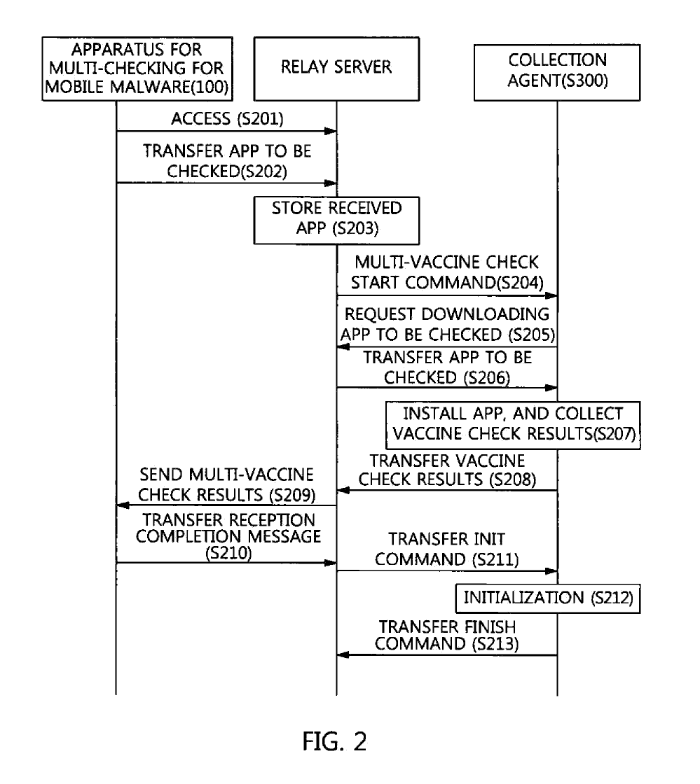

A method of multi-checking for mobile malware using multiple nodes is described in detail below with reference to FIG. 2.

FIG. 2 is a flowchart illustrating the method of multi-checking for mobile malware according to this embodiment of the present invention.

Referring to FIG. 2, an environment to which the method of multi-checking for mobile malware according to this embodiment of the present invention is applied includes the apparatus 100 for multi-checking for mobile malware, the relay server 200, and the collection agents 300 placed in each of the N user terminals 31 or M emulators 32.

The apparatus 100 for multi-checking for mobile malware accesses the relay server 200 connected to one or more N user terminals 31 or M emulators 32 in order to check for malware in a mobile at step S201. When being connected to the relay server 200, the apparatus 100 for multi-checking for mobile malware may make access in the form of software, such as a web program or a Windows/Linux execution file.

The apparatus 100 for multi-checking for mobile malware transfers an app to be checked to the relay server 200 at step S202.

The relay server 200 stores the received app to be checked at step S203. Thereafter, the relay server 200 transfers a multi-vaccine check start command START to the collection agents 300 at step S204.

The collection agents 300 receive the multi-vaccine check start command START and request the relay server 200 to download the app to be checked in order to perform multi-vaccine checking at step S205.

In response to the requests from the collection agents 300, the relay server 200 transfers the app to be checked to the collection agents 300 at step S206.

The collection agents 300 install the received app to be checked and collect vaccine check results at step S207. Before step S207, the task of installing a mobile vaccine on the user terminals 31 or the emulators 32 corresponding to the collection agents 300 needs to be performed.

The collection agents 300 transfer the vaccine check results, collected at step S207, to the relay server 200 at step S208.

The relay server 200 transfers the vaccine check results received from the one or more collection agents 300, that is, multi-vaccine check results, to the apparatus 100 for multi-checking for mobile malware in real time at step S209.

When receiving the multi-vaccine check result from the relay server 200, the apparatus 100 for multi-checking for mobile malware transfers a reception completion message to the relay server 200 at step S210.

After receiving the reception completion message, the relay server 200 transfers an initialization command INIT for the user terminals 31 or emulators 32, corresponding to the multi-vaccine check results, to the collection agents 300 at step S211.

In response to the initialization command, the collection agents 300 initialize the user terminals 31 or the emulators 32 at step S212, and transfer an initialization finish command FINISH indicative of the completion of the initialization to the relay server 200 at step S213.

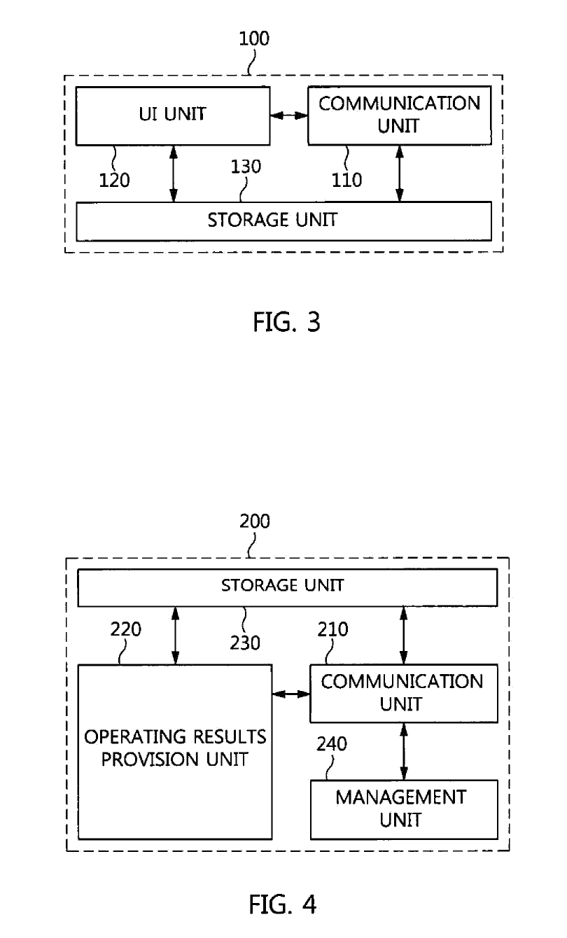

The configuration of the apparatus 100 for multi-checking for mobile malware is described in detail below with reference to FIG. 3.

FIG. 3 is a diagram schematically illustrating the configuration of the apparatus 100 for multi-checking for mobile malware according to an embodiment of the present invention.

Referring to FIG. 3, the apparatus 100 for multi-checking for mobile malware includes a communication unit 110, a user interface (UI) unit 120, and a storage unit 130.

The communication unit 110 communicates with the relay server 200. The communication is performed via socket communication, and a communication protocol may be various.

Before sending an app to be checked to the relay server 200, the UI unit 120 may receive the app to be checked from a user or provide vaccine check results to the user.

The storage unit 130 stores a history of vaccine check results that are received from the relay server 200 and that correspond to the app to be checked. Furthermore, the storage unit 130 stores basic information about the app to be checked and a history of multi-vaccine check results received from the relay server 200.

The relay server 200 is described in detail below with reference to FIG. 4

FIG. 4 is a diagram schematically illustrating the relay server 200 according to an embodiment of the present invention.

Referring to FIG. 4, the relay server 200 includes a communication unit 210, an operating results provision unit 220, a storage unit 230, and a management unit 240.

The communication unit 210 functions as an intermediary between the apparatus 100 for multi-checking for mobile malware and the collection agents 300, and is formed of a socket program. In this case, a communication protocol may be various.

The operating results provision unit 220 corresponds to a UI indicative of the operating results of the relay server 200. The operating results provision unit 220 may be replaced with a UI developed using binary or web programming based on Windows/Linux, but the present invention is not limited thereto.

The storage unit 230 stores a vaccine checking history and results corresponding to an app to be checked, which are received from the apparatus 100 for multi-checking for mobile malware. In this case, a specific history stored in the storage unit 230 may be checked, modified or deleted by the operating results provision unit 220, or a history may be added to the storage unit 230 by the operating results provision unit 220.

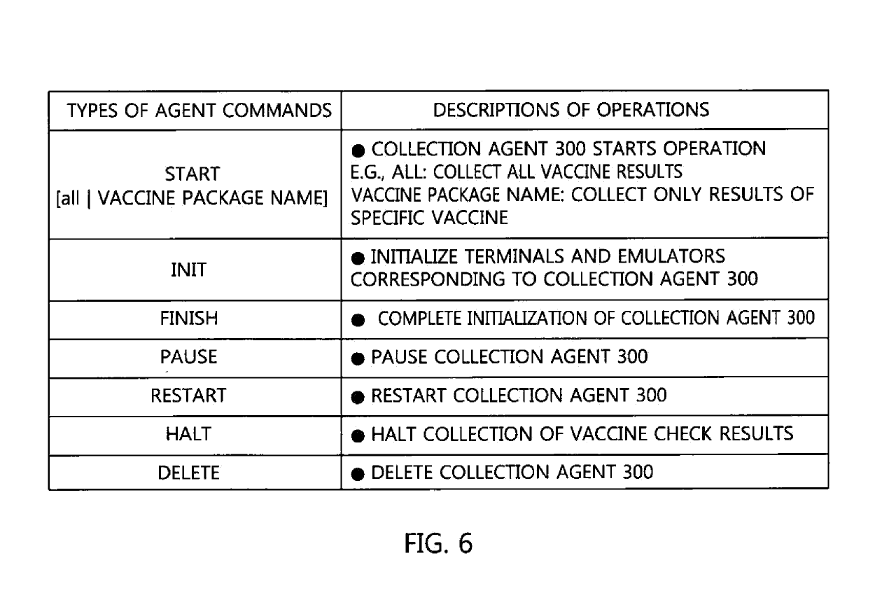

The management unit 240 manages commands to be delivered to the collection agents 300. In this case, the commands may be represented as in FIG. 6. FIG. 6 illustrates the types of agent commands and descriptions of the operations of the commands.

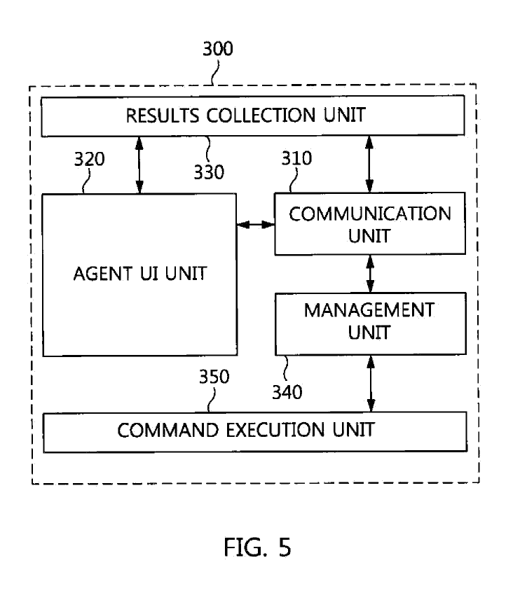

The collection agent 300 is described in detail below with reference to FIG. 5.

FIG. 5 is a diagram schematically illustrating the collection agent 300 according to an embodiment of the present invention.

Referring to FIG. 5, the collection agent 300 includes a communication unit 310, an agent UI unit 320, a results collection unit 330, a management unit 340, and a command execution unit 350.

The communication unit 310 communicates with the relay server 200, and is formed of a socket program. In this case, a communication protocol may be various.

The agent UI unit 320 corresponds to a UI configured to provide information about vaccines, an app to be checked and current commands transmitted and received to and from the relay server 200.

If the OS of the user terminal 31 or emulator 32 where the collection agent 300 is located is the Android mobile OS, the results collection unit 330 may use accessibility information. In this case, the accessibility information provides a text to speech (TTS) service to persons who are visually impaired. The TTS service is a service in which a text message or information about each app is output in voice. If the accessibility information is used, even a person who is visually impaired may control a smart phone using gestures combined with voice outputs. The representative accessibility information of the Android mobile OS includes the function of providing a user with a message in a “notification” form. For example, when an app is installed, a mobile vaccine automatically scans the app, and sends the scan results of the app using a message in a “notification” form. From the viewpoint of a user, the message in a “notification” form may be used to develop the function of collecting the check results of an Android mobile vaccine.

The management unit 340 refers to commands that may be transmitted and received between the collection agents 300 and the relay server 200. For the commands, refer to the agent commands and the descriptions of the operations of the respective commands illustrated in FIG. 6.

The command execution unit 350 includes the functions of performing the actual functions of commands received when the commands are transmitted to and received from the relay server 200. That is, the command execution unit 350 enables the collection agents 300 to perform operations defined with respect to respective START, INIT, FINISH, RESTART, HALT and DELETE corresponding to the agent commands illustrated in FIG. 6.

As described above, the present invention can efficiently reduce the time it takes to check multiple mobile vaccines because a maximum of N×M collection agents 300 are arranged using the N user terminals 31 or the M emulators 32, mobile vaccines are checked in parallel and the check results are collected using the N×M collection agents 300. Furthermore, the apparatus 100 for multi-checking for mobile malware can efficiently analyze check results because the check results are collected through the relay server 200 and only results collected by a specific server are monitored.

Accordingly, the present invention can further increase the accuracy of malware check results by checking a group of mobile vaccines with respect to the same malware. Furthermore, since mobile vaccine check results can be collected in a short period in real time, a malware app can be prevented from being spread by applying the present invention to a mobile app market environment that requires enhanced security.

Furthermore, the apparatus for multi-checking for mobile malware can use various malware detection algorithms corresponding to respective vaccines using multiple mobile vaccines, and can contribute to the improvement of security of a terminal adopting a mobile OS because the detection results of various vaccines can be compared and analyzed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of multi-checking for mobile malware, the method being performed by at least one relay server located between a apparatus for multi-checking for mobile malware and a plurality of collection agents located in respective user terminals or emulators, the method comprising:
receiving, by the relay server, an app to be checked from the apparatus for multi-checking for mobile malware;
transferring the app to be checked to the plurality of collection agents;
collecting vaccine check results of the app to be checked from the plurality of collection agents; and
transferring the collected vaccine check results to the apparatus for multi-checking for mobile malware.

2. The method of claim 1, further comprising, before collecting the vaccine check results, installing a mobile vaccine on the user terminals or emulators corresponding to the collection agents.

3. The method of claim 1, wherein transferring the collected vaccine check results to the apparatus for multi-checking for mobile malware comprises:
receiving a reception completion message from the apparatus for multi-checking for mobile malware;
transferring an initialization command for one or more user terminals or emulators, corresponding to the collected vaccine check results, to the collection agent; and
receiving an initialization finish command indicative that the initialization has been completed in response to the initialization command.

4. The method of claim 1, wherein when the app to be checked is transferred to the plurality of collection agents, the app to be checked is automatically installed on the plurality of collection agents.

5. A method of checking for malware of user terminals or emulators using an apparatus for multi-checking for mobile malware, the method comprising:
accessing at least one relay server located between the apparatus for multi-checking for mobile malware and a plurality of collection agents located in the respective, user terminals or emulators;
transferring an app to be checked to the relay server; and
receiving vaccine check results for the app to be checked, obtained by the plurality of collection agents, from the relay server.

6. The method of claim 5, wherein receiving the vaccine check results comprises:
transferring, by the relay server, the app to be checked to the plurality of collection agents; and
collecting the vaccine check results of the app to be checked from the plurality of collection agents.

7. An apparatus for multi-checking for mobile malware, comprising:
a communication unit configured to communicate with at least one relay server; and
a user interface (UI) unit configured to receive an app to be checked from a user before sending the app to the relay server, or to provide the user with check results of the app obtained by a plurality of collection agents located in respective user terminals or emulators based on the app.

8. The apparatus of claim 7, wherein the relay server communicates with the plurality of collection agents located in the respective user terminals or emulators.

9. The apparatus of claim 7, wherein the communication unit is formed of a socket program.

10. The apparatus of claim 7, further comprising a storage unit configured to store the vaccine check results of the app obtained by the plurality of collection agents.
